(19) United States
(12) Patent Application Publication
(10) Pub. No.: US 2013/0074152 A1
(43) Pub. Date: Mar. 21, 2013

(54) METHOD AND DEVICES FOR SECURITY ASSOCIATION (SA) BETWEEN DEVICES

(71) Applicant: Weon-Il Jin, Suwon-si (KR)

(72) Inventor: Weon-Il Jin, Suwon-si (KR)

(73) Assignee: SAMSUNG ELECTRONICS CO., LTD., Suwon-si (KR)

(21) Appl. No.: 13/365,293

(22) Filed: Feb. 3, 2012

(30) Foreign Application Priority Data
Sep. 19, 2011 (KR) 10-2011-0094189

(51) Int. Cl. G06F 21/00

(52) U.S. Cl. 726/3

(57) ABSTRACT

In one aspect, there is provided a method and apparatus for security association (SA) upon communication between devices. When a mobile device is connected to another mobile device without subscribing to a specific service or a private network, SA may be established. For example, the SA may be used for resource saving and secure connections of resource poor devices (for example, a medical patch) having a relatively poor resource, such as insufficient battery power or computing power.

### CROSS REFERENCE TO RELATED APPLICATIONS

This application claims the benefit under 35 U.S.C. §119(a) of a Korean Patent Application No. 10-2011-0094189, filed on Sep. 19, 2011, the entire disclosure of which is incorporated herein by reference for all purposes.

### BACKGROUND

1. Field

The following description relates to a technique for Security Association (SA) between devices.

2. Description of the Related Art

With development of information and communications technologies, information exchange between devices actively takes place. In a communication environment where two or more devices are connected to each other for information exchange, security association (SA) is necessary. In general, mobile terminals secure personal information through a second channel, such as infrared communication, Bluetooth communication, etc. However, users who have no special knowledge about high technologies have difficulties in utilizing an SA method. That is, for secure communications between devices, a predetermined length of an encryption key should be shared between them or a certificate issued from certification authority (CA) is needed. For example, SA between two devices based on Bluetooth is established by pairing or bonding requiring a passkey or PIN input from a user. However, personal mobile devices generally have a simple user interface (UI) that cannot share a long key, and paying cost through certification authority to establish SA between devices is also not reasonable. For these reasons, a security technique for resource poor devices having insufficient battery power, computing power, or I/O characteristics is needed.

### SUMMARY

In one general aspect, there is provided a method for security association (SA) between a plurality of devices. The method includes, transmitting an SA request from a first device to a second device. The method also includes transmitting an originality verification (OV) request from the second device to the first device. The method includes receiving the OV request and generating OV information at the first device, and transmitting the OV information from the first device to the second device. The method also includes receiving the OV information and performing OV based on the OV information at the second device.

The transmitting of the OV request at the second device may include, determining whether originality exists in an originality storage of the second device. The transmitting of the OV request at the second device may also include requesting the first device to send originality in response to no originality existing in the originality storage. The transmitting of the OV request may further include receiving originality from the first device and storing the originality in the originality.

The method may further include, generating a predetermined message at the second device and transmitting the predetermined message to the first device in response to the result of the OV being false.

The method may further include configuring the originality to include at least one of a random number location, a function value of a random number, a public key of the first device, and lifetime information of the function value.

The method may further include configuring OV request may include the random number location and the lifetime information of the function value. The method may further include configuring OV information may include a function value obtained by applying a one-way function to the random number, using the random number location and the lifetime information of the function value, which are included in the OV request.

The method may further include receiving of the OV information and the performing of the OV may include, at the second device, applying the function to the function value of the OV information and comparing the resultant function value with the function value included in the originality.

In another general aspect, there is provided a first device including a security association (SA) requestor configured to transmit an SA request to a second device. The first device also includes an originality issuer including an originality verification (OV) generator. The OV generator is configured to receive an OV request from the second device in response to the SA request, to generate OV information based on the OV request, and to transmit the OV information to the second device.

The originality issuer may further include an originality generator configured to receive the originality request from the second device, to generate originality, and to transmit the originality to the second device.

The originality may include at least one of a random number location, a function value of a random number, lifetime information of the function value, and a public key.

The first device may further include a crypto engine configured to generate the random number according to a request from the originality generator and to apply a one-way function to the random number a predetermined number times to generate a function value.

The OV request may include at least one of the random number locations and the lifetime information of the function value. The OV information may also include a function value obtained by applying a one-way function to the random number, using the random number location and the lifetime information of the function value.

In another general aspect, there is provided a second device including an originality verification (OV) request generator and an OV prover. The OV request generator is configured to receive an SA request from the first device, to generate an OV request for originality stored in an originality storage, and to transmit the OV request to the first device. The OV prover is configured to receive OV information from the first device and to perform OV based on the OV information.

When receiving an SA request from the first device, the originality confirmer may further include an originality requestor configured to determine whether originality exists in the originality storage, to transmit an originality request to the first device in response to no originality existing in the originality storage, to receive originality from the first device, and to store the received originality in the originality storage.

The OV prover may perform the OV by requesting a crypto engine to apply the function to a function value of the OV information. The OV prover may also perform the OV by comparing the function value which a one-way function is applied by the crypto engine to a function value of the originality stored in the originality storage.

The second device may further include a message generator configured to generate, in response to the result of the OV being false, a predetermined message and transmit the predetermined message to the first device.

When receiving a new SA request from the first device that has received the predetermined message, the originality requestor may delete the originality stored in the originality storage, and transmit a new originality request to the first device.

In another general aspect, there is provided a computer program embodied on a computer readable medium, the computer program being configured to control a processor to perform security association (SA) between a plurality of devices, including transmitting an SA request from a first device to a second device. The computer program being configured to control the processor to transmit an originality verification (OV) request from the second device to the first device, and receive the OV request and generating OV information at the first device, and transmitting the OV information from the first device to the second device. The computer program being configured to control the processor to receive the OV information and performing OV based on the OV information at the second device.

Other features and aspects will be apparent from the following detailed description, the drawings, and the claims.

### BRIEF DESCRIPTION OF THE DRAWINGS

FIG. 1 is a diagram illustrating a configuration example of devices for security association (SA).

FIG. 2 is a flowchart illustrating an example of a method for security association (SA) between devices.

FIG. 3 is a diagram illustrating an example of a first device.

FIG. 4 is a diagram illustrating an example of a second device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

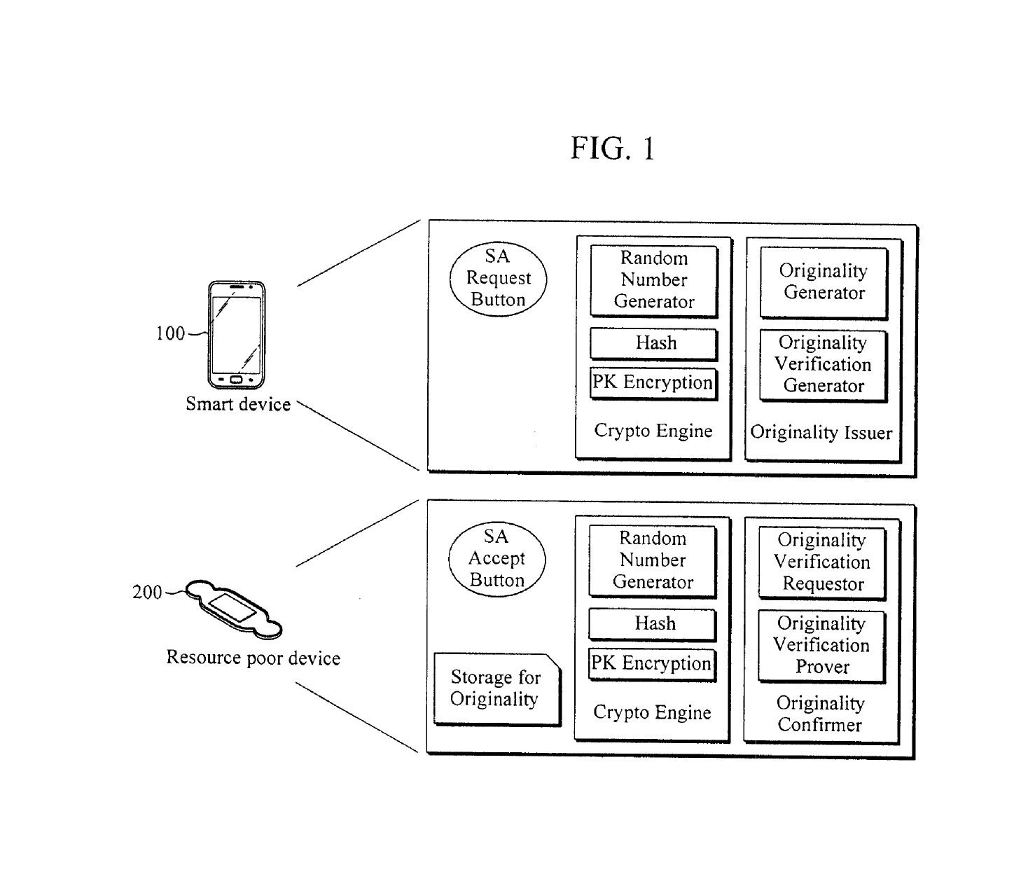

FIG. 1 is a diagram illustrating a configuration example of devices for security association (SA). FIG. 1 shows the configurations of first and second devices 100 and 200 between which the SA is established. A smart mobile device (for example, a smart phone) having a relatively abundant resource, such as a battery, is illustrated as an example of the first device 100. A resource poor device (for example, a medical patch) having a relatively poor resource, such as insufficient battery power or computing power, is illustrated as an example of the second device 200. The medical patch may be a thermometer, a pulse oximeter, a pulse/blood pressure, an insulin pump, and the like.

The first device 100 may include an SA request button to enable a user to request establishing the SA with the second device 200, which the first device 100 wants to access. The first device 100 may include an originality issuing module to generate originality according to a request from the second device 200 and to transmit the originality to the second device 200. The first device 100 may also include a Crypto engine that may be used to issue originality. The second device 200 may include an SA acceptance button to enable a user to accept an SA request from the first device 100. The second device 200 may also include an originality confirmer to confirm an issuer of originality, and a crypto engine that may be used to confirm the issuer of originality.

In one illustrative aspect, the first and second devices 100 and 200 may establish SA without having to utilize any other means, except for a main communication method. The main communication method may be a predetermined method for communication between the first and second devices 100 and 200, and may be infrared communication, Bluetooth communication, a USB cable, and the like.

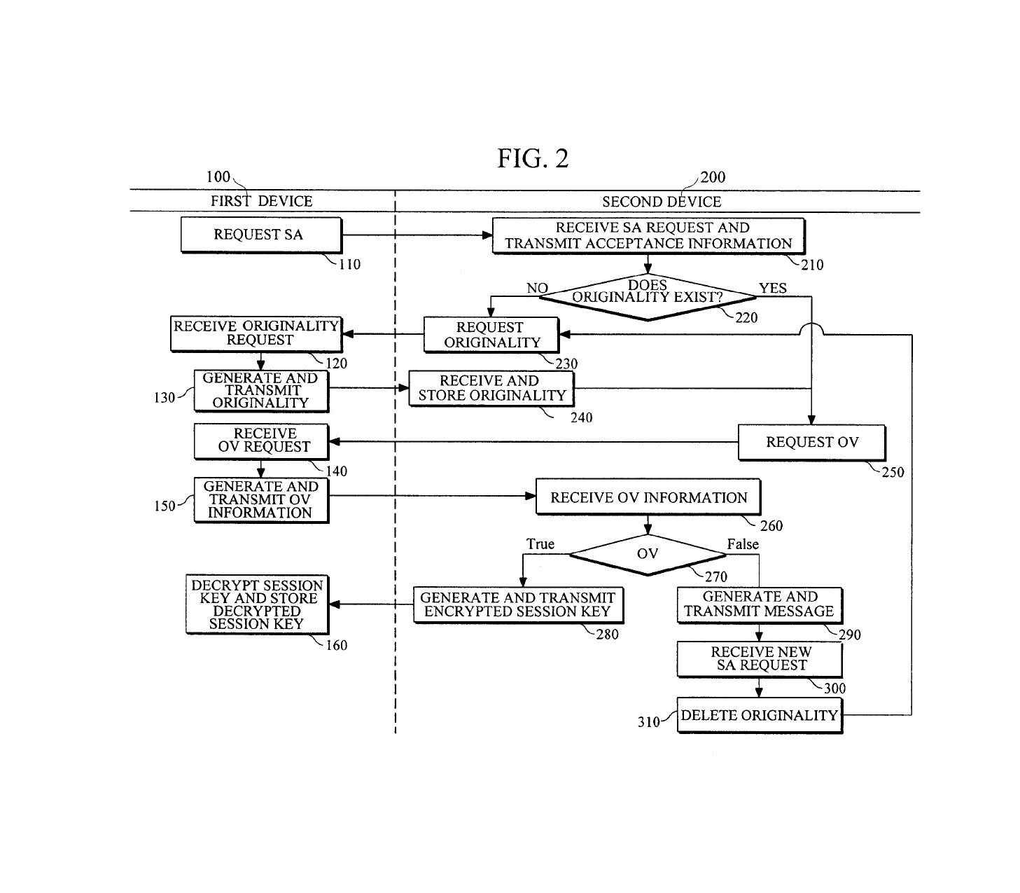

FIG. 2 is a flowchart illustrating an example of a method for SA between the first and second devices 100 and 200. First, the first device 100 generates the SA request and transmits the SA request to the second device 200 (110). The second device 200 receives the SA request (210), and may transmit acceptance information to the first device 100 to notify that the SA request has been accepted.

Then, the second device 200 determines whether originality exists in an originality storage 240 (220). In response to no originality existing in the originality storage 240, the second device 200 generates an originality request and transmits the originality request to the first device 100; thus, requesting the first device 100 to issue originality (230). Then, the first device 100 receives the originality request from the second device 200 (120), issues originality, and transmits the originality to the second device 200 (130). The second device 200 receives the originality from the first device 100 and stores the originality in the originality storage. The originality generated by the first device 100 includes a random number location, a one-way function value obtained by applying the function to a random number k times (the k value is the lifetime of the function value), and a public key. The one-way function is a function that is easy to compute on every input, but hard to invert given the image of a random input. A hash function is a kind of the one-way function.

In response to originality existing in the originality storage or in response to a new originality being received from the first device 100 and stored in the originality storage, the second device 200 generates an originality verification (OV) request (250) and transmits the OV request to the first device 100; thus, requesting the first device 100 to send OV information (140). In one illustrative aspect, the OV request may include the random number location and the lifetime k of the function value, which are included in the originality. In response to the OV request, the first device 100 generates OV information and transmits the OV information to the second device 200, so that the second device 200 can confirm an issuer of the originality (150). The OV information includes a function value obtained by applying the function to the random number corresponding to the random number location received from the second device 200 k−1 times.

The second device 200 receives the OV information (260), and verifies the originality based on the OV information to confirm an issuer of the originality (270). In one illustrative example, a method of verifying originality may include comparing a function value obtained by applying the function to the function value included in the OV information one time with the function value stored in the originality storage. The method may then determine whether the function value in the OV information is identical to the function value stored in the originality storage, where an issuer of the originality is the first device 100 that requested SA. In one illustrative aspect, the method of verifying originality between the first and second devices 100 and 200 may be performed in phases, as shown in Table 1 below. In response to the result of the OV being “true”, the function value stored in the originality storage and the lifetime information of the function value are respectively substituted by the function value and the (k−1) value included in the OV information received from the first device 100.

TABLE 1

| | First Device | Second Device |
|---|---|---|
| Issue | Generate | Store Hash^{k}(R) |
| Originality | Hash^{k}(R) | |
| Verify | Generate | Compare Hash Value Hashed One Time |
| Originality | Hash^{k-1}(R) | with Hash^{k}(R) and Store Hash^{k-1}(R) |
| (1st) | | when the Hash Value Is Identical |
| | | to Hash^{k}(R) |
| Verify | Generate | Compare Hash Value Hashed One Time |
| Originality | Hash^{k-2}(R) | with Hash^{k-1}(R) and Store Hash^{k-2}(R) |
| (2nd) | | when the Hash Value Is Identical |
| | | to Hash^{k-1}(R) |
| . . . | . . . | . . . |
| Verify | Generate R | Discard Originality After |
| Originality | | Verification |
| (kth) | | |

An originality verification process is explained in the table 1. According to the table 1, the second device 200 may apply a simple one-way function like a function function. to verify originality so that SA can be effectively established even between devices with relatively poor resources.

Then, the second device 200 generates a session key, encrypts the session key with the public key included in the originality issued by the first device 100, and transmits the encrypted session key to the first device 100 (280). The first device 100 receives the encrypted session key, decrypts the session key with the private key, and stores the decrypted session key therein (160). In the alternative, in response to the result of the OV being “false”, the second device 200 may generate a predetermined message and transmit the predetermined message to the first device 100 (290). In one example, the predetermined message may be a message such as “You are false! New SA?” for notifying that the OV has failed and requesting new SA. In response to the first device 100 receiving the message and transmitting a new SA request to the second device 200, the second device 200 receives the new SA request from the first device 100 (300) and deletes the originality stored in the originality storage (310). Thereafter, the process proceeds to operation 230 to request the first device 100 to issue originality. However, the predetermined message may be a message such as “You are false! SA terminate” for notifying that the OV has failed and SA has to be terminated.

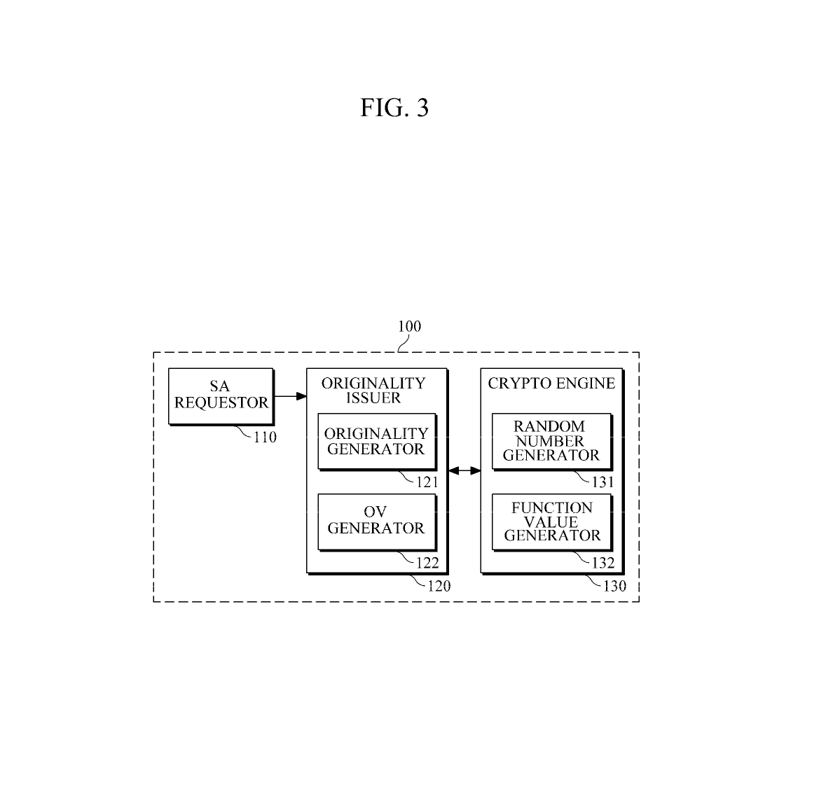

FIG. 3 is a diagram illustrating an example of the first device 100. Referring to FIG. 3, the first device 100 may include an SA requestor 110 and an originality issuer 120. The SA requestor 110 transmits an SA request to the second device 200 (see FIG. 2) that the first device 100 wants to access. For example, a user who may wish to establish SA with the second device 200 or a target device would press the SA request button (see FIG. 1) on his or her own first device 100 or smart device to transmit an SA request to the second device 200. Upon receipt of the SA request and to confirm an issuer of originality from the second device 200, the originality issuer 120 would generate OV information and transmit the OV information to the second device 200 so that the second device 200 can confirm the issuer of originality. The first device 100 may further include a crypto engine 130. In one aspect, the crypto engine 130 may receive an encrypted session key, decrypt the session key with a private key, and store the decrypted session key.

According to an example, the originality issuer 120 may include an originality generator 121. The originality generator 121 receives an originality request from the second device 200, generates originality, and transmits the originality to the second device 200. That is, in response to an SA request from the first device 100, the second device 200 determines whether originality issued by the first device 100 exists, The second device 200 may also request the first device 100 to issue originality in response to no originality issued by the first device 100 exists. In one example, the originality generated by the originality generator 121 of the first device 100 may include one or more of a random number location, a function value of the random number, the lifetime of the function value, and a public key. In one aspect, the function value of the random number included in the originality may be a value obtained by applying the function to the random number k times using the function, wherein k is the lifetime of the function value. The k is an integer greater than 0. A meaning of the lifetime k is that a verification of an originality can be performed up to k times if the function value is obtained by applying a one-way function to the random number k times at first. The random number is an integer greater that 0. The random number is an arbitrary number generated by cryptor engine 130 according to request of an originality generator 121.

The originality issuer 120 may include an OV generator 122 to receive the OV request from the second device 200, which received the SA request, generate OV information based on the OV request, and transmit the OV information to the second device 200.

In one aspect, the OV request may include one or more of the random number location and the lifetime k of the function value. As described above, in response to the SA request from the first device 100, the second device 200 receives and stores originality issued by the first device 100, generates an OV request including a random number location and the lifetime of a function value among information included in the stored originality in order to confirm an issuer of originality, and transmits the OV request to the first device 100. When the originality stored in the second device 200 is originality initially issued by the first device 100, the OV request may include the random number location and the lifetime k of the function value, which are included in the originality.

Furthermore, the OV information may include a function value obtained by applying the function to a random number R corresponding to the random number location. That is, the OV generator 122 may use the random number location included in the OV request received from the second device 200 to extract a random number R corresponding to the random number location. The OV generator 122 may apply the function to the random number R a predetermined number times to generate a function value. In one example, the predetermined number may be smaller by 1 than the lifetime value of the received function value. For example, when the lifetime of the received function value is k, the OV generator 122 may apply the function to the random number k−1 times to generate a function value. The second device 200 may then receive the OV information, apply the function to the received function value one time, compare the resultant function value with the function value of the stored originality, and confirm an issuer of the originality according to whether or not the resultant function value is identical to the function value of the originality.

The crypto engine 130 may include a random number generator 131 and a function value generator 132. The random number generator 131 may generate a random number that is to be included in originality, according to a request from the originality generator 121. The function value generator 132 may apply the function to the random number k times using a one-way function to generate a function value for the random number. Also, the random number generator 131 may extract a random number corresponding to the random number location included in the OV request received by the OV generator 122, according to a request from the OV generator 122. The function value generator 132 may generate a function value for the extracted random number using the lifetime information of the function value included in the OV request.

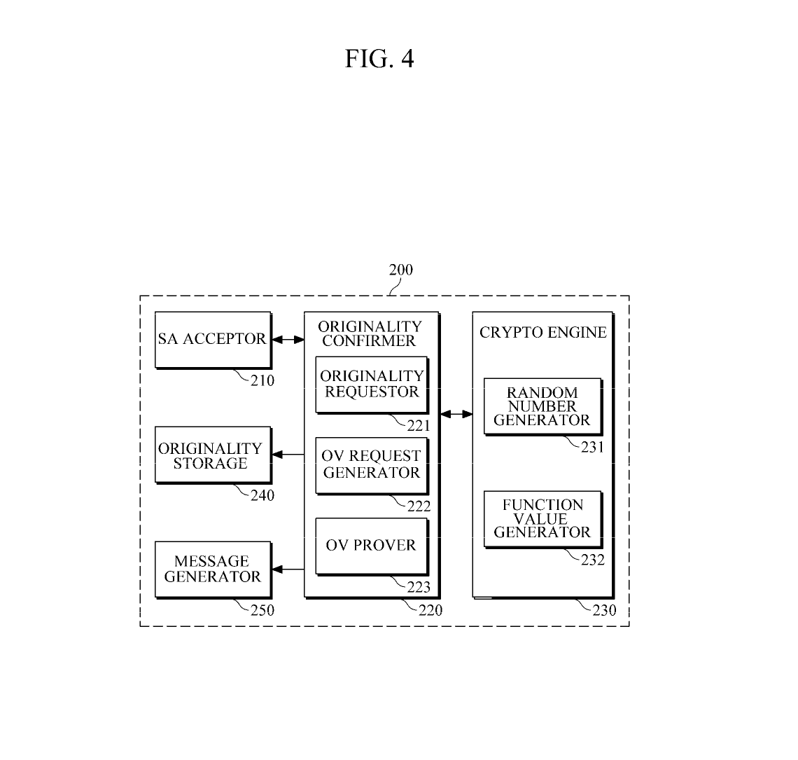

FIG. 4 is a diagram illustrating an example of the second device 200. The second device 200 establishes SA with the first device 100. The second device 200 may be a resource poor device (for example, a medical patch) having a relatively poor resource, such as insufficient battery power or computing power compared to the first device 100. A person of ordinary skill in the art will recognize that the second device 200 is not limited to such a resource poor device and other similar devices may be used. The second device 200 includes an originality confirmer 220 and an originality storage 240.

The originality storage 240 receives and stores originality issued by the first device 100. The originality confirmer 220 determines, when receiving an SA request from the first device 100, whether originality stored in the originality storage 240 is identical to originality issued by the first device 100.

The second device 200 may further include a crypto engine 230. When the originality confirmer 220 determines that an issuer of originality stored in the originality storage 240 is the first device that has requested SA, the crypto engine 230 generates a session key, and encrypts the session key with a public key included in the originality.

The originality confirmer 220 may include an OV request generator 222 and an OV prover 223. The OV request generator 222 generates, when receiving an SA request from the first device 100, an OV request about originality stored in the originality storage 240, and transmits the OV request to the first device 100. As described above, the originality stored in the originality storage 240 may include, but is not limited to, a random number location, a function value of the random number, the lifetime of the function value, and a public key. The OV request generator 222 extracts the random number location and the lifetime of the function value from the originality stored in the originality storage 240, generates an OV request, and transmits the OV request to the first device 100. Once the OV request from the OV request generator 222 is received, the first device 100 extracts a random number corresponding to the random number location, applies the one-way function to the extracted random number a predetermined number times using the one-way function to generate OV information, and transmits the OV information to the second device 200. In one aspect, the predetermined number may be smaller by 1 than the lifetime of the function value. The OV prover 223 receives the OV information from the first device 100 and verifies originality. The OV prover 223 may then verify originality by applying the function to the function value included in the OV information one time using the crypto engine 230 and by comparing the resultant function value with the function value of the originality stored in the originality storage 240 to determine whether the resultant function value is identical to the function value of the stored originality. For example, when a function value of a random number stored in the originality storage 240 is a value obtained by k-times applying the function, the lifetime of the function value becomes k. Then, the OV request generated by the OV request generator 222 includes the location of the random number and the lifetime k of the function value. The first device 100 receives the OV request, applies the function to a random number corresponding to the random number location k-1 times using the function, and transmits the resultant function value to the second device 200. The OV prover 223 receives the function value from the first device 100 and applies the function to the function value one time through the crypto engine 230. As a result, because the random number is a value obtained by k-times applying the function, the function value applied by the OV prover 223 is compared with the function value stored in the originality storage 240 to determine whether the first device 100 is an original issuer. For example, when the first device 100 is not an issuer of the originality stored in the second device 200, the first device 100 may not know an initially generated random number, and accordingly, the function value applied by the OV prover 223 may be different from the function value stored in the originality storage 240.

In response to determining that the first device 100 is an original issuer based on the result of the comparison, the function value stored in the originality and the lifetime k of the function value are respectively substituted by the function value included in the received OV information and a value k−1, which is a result from subtracting 1 from the lifetime k of the function value.

In response to the result of OV by the OV prover 223 being “true”, the crypto engine 230 may generate and encrypt a session key, and transmit the encrypted session key to the first device 100. At this time, the crypto engine 230 may encrypt the session key with the public key included in the originality stored in the originality storage 240. In one aspect, the crypto engine 230 may include a random number generator 231 and a function value generator 232. The random number generator 231 may generate the session key when the result of the OV is “true”. The function value generator 232 may apply the function to the function value of the OV information received from the first device 100 one time; thus, generating a function value.

The second device 200 may further include an SA acceptor 210. The SA acceptor 210 may receive an SA request from the first device 100, may generate SA acceptance information, and may transmit the SA acceptance information to the first device 100.

Also, the originality confirmer 220 may further include an originality requestor 221. The originality requestor 221 may receive an SA request from the first device 100 and may determine whether originality exists in the originality storage 240. In response to no originality existing in the originality storage 240, the originality requestor 221 may transmit an originality request to the first device 100, receives originality from the first device 100, and may store the received originality in the originality storage 240.

Also, the second device 200 may further include a message generator 250. In response to the result of OV by the OV prover 223 being “false”, that is, when an issuer of the originality stored in the originality storage 240 is not the first device 100 that has requested SA, the message generator 250 generates a predetermined message and transmits the predetermined message to the first device 100. The predetermined message may be a message such as “You are false! New SA?” to notify that the OV has failed and to request a new SA. When the first device 100 receives the predetermined message and transmits a new SA request to the second device 200, the originality requestor 221 may receive the new SA request and may delete the originality stored in the originality storage 240. Then, the originality requestor 221 may transmit an originality request to the first device 100 to request the first device 100 to issue new originality. The predetermined message may be a message such as “You are false! SA terminate” to notify that the OV has failed and SA has to be terminated.

As a non-exhaustive illustration only, the first device described herein may refer to a mobile device such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

It should be noted that many of the elements illustrated in FIGS. 1, 3, and 4 and described in this specification have been presented as a generator, a confirmer, an engine, a requestor, and an acceptor in order to more particularly emphasize their implementation independence. For example, the generator, the confirmer, the engine, the requestor, and the acceptor may be implemented as a hardware circuit including custom very large scale integration (“VLSI”) circuits or gate arrays, off-the-shelf semiconductors such as logic chips, transistors, or other discrete components. The generator, the confirmer, the engine, the requestor, and the acceptor may also be implemented as a processing device. The processing device may be implemented using one or more general-purpose or special purpose computers, such as, for example, a processor, a controller, and an arithmetic logic unit, a digital signal processor, a microcomputer, a field programmable gate arrays, programmable array logic, programmable logic devices or the like, a microprocessor or any other device capable of responding to and executing instruction in a defined manner.

One having ordinary skill in the art will readily understand that the invention as discussed above may be practiced with steps in a different order, and/or with hardware elements in configurations which are different than those which are disclosed.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method for security association (SA) between a plurality of devices, the method comprising:
transmitting an SA request from a first device to a second device;
transmitting an originality verification (OV) request from the second device to the first device;
receiving the OV request and generating OV information at the first device, and transmitting the OV information from the first device to the second device; and
receiving the OV information and performing OV based on the OV information at the second device.

2. The method of claim 1, wherein the transmitting of the OV request at the second device comprises:
determining whether originality exists in an originality storage of the second device;
requesting the first device to send originality in response to no originality existing in the originality storage;
receiving originality from the first device and storing the originality in the originality storage.

3. The method of claim 1, further comprising:
generating a predetermined message at the second device and transmitting the predetermined message to the first device in response to the result of the OV being false.

4. The method of claim 2, further comprising:
configuring the originality to include at least one of a random number location, a function value of a random number, a public key of the first device, and lifetime information of the function value.

5. The method of claim 4, further comprising:
configuring the OV request to include the random number location and the lifetime information of the function value.

6. The method of claim 5, further comprising:
configuring the OV information to include a function value obtained by applying a one-way function to the random number, using the random number location and the lifetime information of the function value, which are included in the OV request.

7. The method of claim 6, wherein the receiving of the OV information and the performing of the OV at the second device comprises:
applying the function to the function value of the OV information and comparing the resultant function value with the function value included in the originality.

8. A first device, comprising:
a security association (SA) requestor configured to transmit an SA request to a second device; and
an originality verification (OV) generator configured to receive an OV request from the second device in response to the SA request, to generate OV information based on the OV request, and to transmit the OV information to the second device.

9. The first device of claim 8, further comprising:
an originality generator configured to receive the originality request from the second device, to generate originality, and to transmit the originality to the second device.

10. The first device of claim 9, wherein the originality comprises at least one of a random number location, a function value of a random number, lifetime information of the function value, and a public key.

11. The first device of claim 9, further comprising:
a crypto engine configured to generate a random number according to a request from the originality generator and to apply a one-way function to the random number a predetermined number times to generate a function value.

12. The first device of claim 8, wherein the OV request comprises one or more of the random number location and the lifetime information of the function value, and
the OV information comprises a function value obtained by applying an one-way function to the random number, using the random number location, and the lifetime information of the function value.

13. A second device, comprising:
an originality verification (OV) request generator configured to receive a security association (SA) request from the first device, to generate an OV request for originality stored in an originality storage, and to transmit the OV request to the first device, and an OV prover configured to receive OV information from the first device and to perform OV based on the OV information.

14. The second device of claim 13, further comprising:
an originality requestor configured to determine whether originality exists in the originality storage when receiving an SA request from the first device, to transmit an originality request to the first device in response to no originality existing in the originality storage, to receive originality from the first device, and to store the received originality in the originality storage.

15. The second device of claim 14, wherein the OV prover is configured to perform the OV by requesting a crypto engine to apply a one-way function to a function value of the OV information, and comparing the function value which the function is applied by the crypto engine to a function value of the originality stored in the originality storage.

16. The second device of claim 14, further comprising:
a message generator configured to, in response to the result of the OV being false, generate a predetermined message and transmit the predetermined message to the first device.

17. The second device of claim 16, wherein when receiving a new SA request from the first device in response to receipt of the predetermined message, the originality requestor deletes the originality stored in the originality storage, and transmits a new originality request to the first device.

18. A non-transitory computer readable storage medium for controlling a processor to perform security association (SA) between a plurality of devices, comprising:
transmitting an SA request from a first device to a second device;
transmitting an originality verification (OV) request from the second device to the first device;
receiving the OV request and generating OV information at the first device, and transmitting the OV information from the first device to the second device; and
receiving the OV information and performing OV based on the OV information at the second device.
